(19) United States
(12) Patent Application Publication
(10) Pub. No.: US 2007/0187170 A1
(43) Pub. Date: Aug. 16, 2007

(54) Method for collection and registration seismic data

(76) Inventors: Eldar Lien, Kj olsdalen (NO); Oyvind Hosoy, Soreidgrend (NO)

Correspondence Address: Francis C Hand;Carella Byrne Bain Gilfillan Cecchi Stewart, and Olstein, 5 Becker Farm Road, Roseland, NJ, 07068-1739, US

(21) Appl. No.: 11/596,688

(22) PCT Filed: Apr. 18, 2005
(86) PCT No.: PCT/NO05/00128

§ 371 Date: Dec. 26, 2006

(30) Foreign Application Priority Data
Apr. 16, 2004 (NO) 2004 1565

(51) Int. Cl. G01V 1/00; G01V 1/04; G01V 1/16

(52) U.S. Cl. 181/110; 181/120; 181/122

(57) ABSTRACT

A method is described for collection of multi-component seismic data based on the use of noise from the installation of a pole together with installing receivers comprised of seismic multi-component geophones and hydrophones. The pole is hammered down to a desired sediment depth and repeatable signals with defined energies are sent out. The receiver cable is comprised of 3-component geophones and hydrophones arranged in a straight line profile, readily in star formation, and is pulled successively, after registration is carried out, in toward the source. One commences with a desired offset and gradually obtains increasing spatial resolution as the recording process progresses. Of special interest will be to arrange the listening cables in the directions where it will be most relevant to drill. One will then obtain valuable data which will make it possible to decide on the optimal drilling direction toward the reservoir, with regard to reduction of the risk of meeting geological danger zones with subsequent operating problems and potential pollution problems.

The present invention relates to methods for collection and registration of acoustic, seismic and geological data at the ocean bottom and underlying formations, based on noise produced from a seismic source, where one or more ocean bottom cables are used, comprising sensor units, a data collecting unit and means for transmitting data to the data collecting unit.

### PRIOR ART

Land-based seismology, based on refraction and 3-component geophones, has a long history. Different sources, such as vibrators, hammers and/or dynamite, are used to generate an acoustic signal. Such an acoustic energy pulse generates different types of waves, which in turn are registered by different geophone set-ups, dependent on which type of information (wave type) one seeks. For these types of land-based seismology, it is easy to get a good connection between the source and the ground and also between the receivers and the ground.

For marine seismic investigations, the situation is different as only pressure waves can be transmitted in water. Norwegian companies have been dominant in the development of marine seismic reflection methods, based on pressure waves. Today's systems use many and long receiver cables with built-in hydrophones, arranged in large towable arrays, where several thousand hydrophones spread out across an area of up to 2 square kilometres are towed behind boats that send out (generate) and receive (register) the seismic signals. The efficiency is enormous, and the amount of data that is registered is incomprehensibly large. The data form the basis for preparation of traditional models of the earth's crust, with focus on mapping of oil and gas.

Because water only transmits pressure waves, the information one can get out of the data will be limited in the main to show reflectors in the ground. What these reflectors represent can often be difficult to determine. Other complimentary methods such as magnetometry, gravimetry and electro-magnetic methods will give complementing information that contributes to increase the probability that one can, with more accuracy, show oil and gas.

An exploration well is planned based on interpretations of three-dimensional (3D) seismic data. First, one places a well casing, typically 0.75-1.1 m in diameter, which is either drilled down, vibrated down or hammered down, into the ocean bottom with a hydraulic hammer. This first well casing can, for example, be 50 m long depending on the firmness of the sediments. The exploration well is set up in that new pipes are drilled inside this first well casing. During explorative drilling, much excitement is associated with how the drilling operation progresses as the drill bit comes down into the different geological structures, as the seismic data has indicated. The drilling process itself is associated with risk, as one does not know with certainty what kind of geological formations the drill bit works through. Many dangers can arise, as one can suddenly meet pockets of gas under large pressure. Such incidents can represent a great danger for the drilling vessel and also for the environment in that gases and oil can flow out to the surroundings.

Great resources are used to reduce the danger for these types of incidents during exploration drilling. The more holes one has drilled, the more information one obtains about the local geological conditions and the probability for drilling related blowouts decreases. As the field gradually is developed into production and is emptied of oil, new seismic examinations are carried out, where registration of shear waves with the help of three-component geophones on the ocean bottom, are used. These are very costly investigations that can lead to detailed geological and geotechnical information about the sediments in the area, and which are able to show how the oil/gas reservoir looks. One will then be able to obtain much more precise information about the reservoir, and how this will develop at any time.

Because of the water column between the ocean surface and the ocean bottom, which represents a physical filter with respect to seismic information that can be registered from a surface vessel, and operative costs connected to this “barrier”, multi-component marine seismology, which comprises a minimum of three component shear waves plus pressure wave, has been of little economic interest. Several different concepts have been proposed, but all have suffered from large and difficult marine operations, large costs and low productivity. Today, it is too costly to operate with both source and receiver on the ocean bottom, and one chooses therefore a compromise where the receivers are placed on the ocean bottom, and one uses traditional surface sources such as air guns. Then, one relies on conversion of wave energy from pressure waves to shear waves in the sediments. This energy conversion leads to a loss of energy and varies from one area to another. The quality of the data is therefore not satisfactory.

U.S. Pat. No. 5,128,900, NO 304203, GB 2186368, U.S. Pat. No. 4,705,137, U.S. Pat. No. 4,730,692 describe several types of seismic ocean bottom sources.

NO 304203 describes a device and a method for generation of seismic shear waves. A hydraulic hammer is used for installing the source and a vibration unit located on the top or at the bottom of a pipe internally in the bottom of a pipe that generates seismic energy which is converted to different wave types that are transmitted to receiver cables localised on the ocean bottom. This gives a costly and complex maritime operation, which at best can be used under very special conditions.

U.S. Pat. No. 5,128,900 describes a marine seismic source which comprises a pipe with a hydraulic source placed at the end of the pipe.

Reference is also made to U.S. Pat. No. 4,835,745, describing a method for radial seismic data collection from a point of a formation with very steep sides mapped in advance.

The source that is to be described in the present invention deviates much from all the sources which are described in the above mentioned publications in that one uses the same hammer that is applied to install a well casing for drilling or an anchor pole as the seismic source.

The receiver system can, for example, be towable ocean bottom cables with data transmission directly to a boat or with local storage sub-sea, or also “stand-alone” receiver stations with local storage of data, which are placed out with the help of ROVs or a combination of these.

It is an object of the present invention to provide a method for collecting seismic data that makes it possible to determine an optimal drilling direction towards a reservoir.

Another object of the present invention is to provide a method for collecting seismic data which drastically reduces the risk of drilling-related incidents, such as, for example, to drill into unknown geological structures in explorative drilling.

It is also an ultimate object of the present invention to use the collected data to construct a much better plan for how the individual oil well should be designed and constructed than one has today. This will provide an optimal design that in turn will lead to increased safety and reduced operating and maintenance costs.

### A SHORT DESCRIPTION OF THE INVENTION

The present invention describes a vessel with a system for generating seismic waves in the underground, and a system for registering seismic data. Both a seismic source and a cable are directly connected to the ocean bottom so that one obtains both different types of waves and has a possibility to register the mentioned type of waves after they have propagated through the uppermost layers of the earth's crust. Of special interest is the registration of three-component shear waves. The operation can be carried out with a vessel, where the cable is laid out on the seabed and the vessel goes to a shooting position. The source is lowered and is installed to a desired sediment depth with the use of the hammer. While this is done one can carry out seismic registering that, in a simple onboard processing, will inform when the source is at the desired sediment depth. The source can be switched from pole hammer to seismic hammer and recordings can be started. Recordings are made until the necessary required amount of data is obtained to get the best possible signal-to-noise ratio. The cable is then pulled in a defined distance towards the source, and new registrations are made. This continues until the nearest receiver has reached a defined distance from the source. The source is then pulled up, the vessel moves to the next shooting position while the cable lies still, and the source is lowered again, and new registrations are carried out. In this way, one can perform simple multi-component ocean bottom seismology as a one-boat operation. One can then make recordings that provide a 2D multi component seismology along given profiles. Registering in a pattern of square can be arranged, to cover an area (3D) or one can follow defined directions, for example, a sector where one wishes to drill, or one wishes to carry out a seismic investigation of the ground along a pipeline route.

The above mentioned objects and other objects are obtained according to the present invention by a method according to the present invention, which is characterised by the characteristic features in the independent claims 1, 2 and/or 3.

Alternative embodiments of the method according to claim 1, 2 and/or 3 are characterised by the characteristic features in the dependent claims 4-8.

An advantage of the present invention is to provide a complete multi-channel seismology of very good quality over a large area, where the spatial resolution gradually increases in towards the source/pole, which is the area one is most interested in. By performing seismology at the same time as one installs such well casings, one will be able to collect this type of data before the presence of oil and gas has been verified, at a very attractive price. The data will be of the best quality, and be of very great economic value because one can plan the field in a completely new and optimal way with respect to a reduction in costs and risks.

Another advantage of the method according to the invention is that it can be used to get a detailed geological/geotechnical knowledge about the conditions along a planned drilling route so that the drilling direction can be optimised.

A further advantage of the method according to the invention is that it reduces exploring and operating costs considerably, in that the collected data will provide information which makes it possible to take decisions based on much more reliable information than is present today.

### DESCRIPTION OF THE FIGURES

The invention shall now be described in more detail with reference to the enclosed drawings, in which:

FIG. 1 shows a typical two-dimensional collecting process.

FIG. 2 shows a seismic ocean bottom source according to prior art.

FIG. 3 shows an example of a formation of ocean bottom cables according to the present invention.

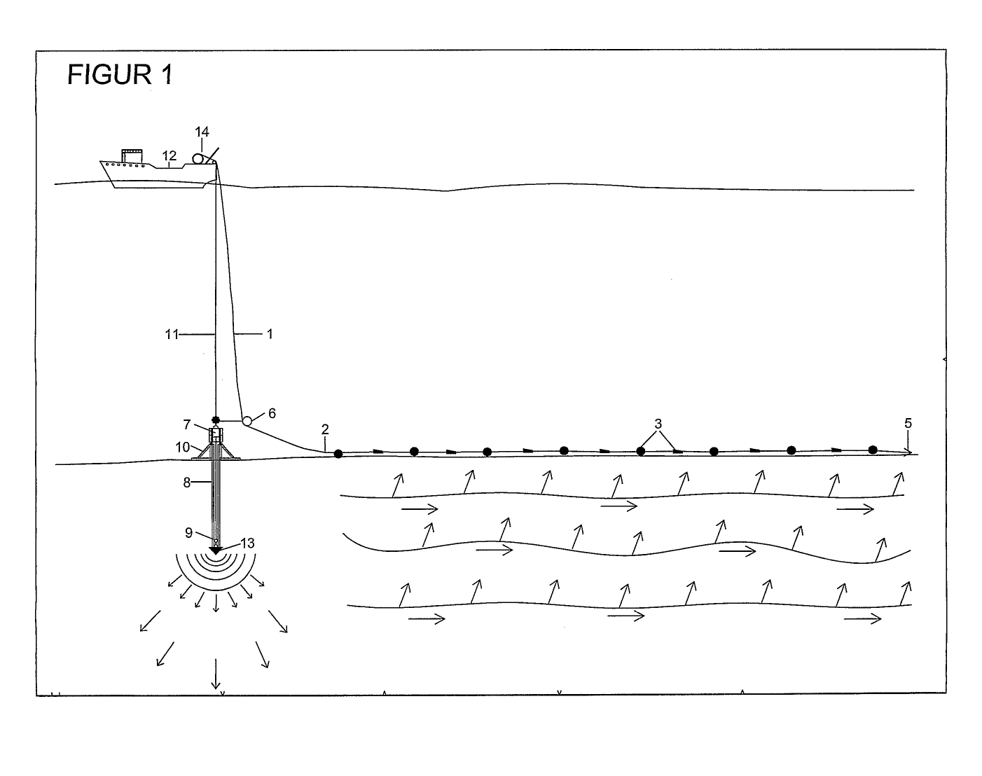

FIG. 1 shows a typical configuration of placing cables 2 on the ocean bottom according to the present invention. The operation can be carried out with the help of a vessel 12, where a cable 1, 2 is laid down to the ocean bottom and the vessel 12 goes to shooting position. A source 13 is lowered and is installed to the desired sediment depth with the use of, for example, a hydraulic hammer 9. As this is carried out, seismic registering is conducted, which, by way of simple processing on board the vessel will inform when the source 13 is at the desired sediment depth. The source 13 is then switched over from pole hammer to seismic hammer and recording of data can commence. This is carried out until one has obtained the necessary amount of data that is required to get the best possible signal-to-noise ratio.

The seismic source 13 can represent the hammer itself that installs the first well casing/pole 8, or a vibrator or hammer 9 which is fitted inside the mentioned well casing 8 after installation of this. One or more cables 2, comprising multi-channel sensor units, such as geophones and/or hydrophones, are placed out in given directions with a given offset, with the source 13 in the centre. As the seismic source 13 produces acoustic signals, either with the help of the hammer 9, or with the help of the installation hammer, acoustic position data are registered in the sensor units 3, 4. The cable/cables 2 can be pulled in towards the source 13 so that a larger area is covered. Registrations are carried out for each position until one has the necessary data. The sensor units lie in long cables that can be pulled in along the ocean bottom towards the source 13, or they can be individual and “stand-alone” registering units which are moved with a Remote Operated Vehicle (ROV).

Application of the method for registering seismic data can be carried out by pre-installation of well casings. By pre-installing preferably 4-8 well casings (multi purpose pipes) and carrying out multi-component seismology at the same time, one will be able to cover the central parts of a potential oil field. The poles 8 can be used for drilling or as a location for seismic ocean bottom sources if one wishes to conduct multi-channel seismology at a later date. Then, one can generate the receiver geometry and in this way obtain a complete 4D multi-component seismic model of the reservoir. The poles 8 can, for example, also be used as a stationary point in connection with larger marine operations and anchorage of temporary or permanent floating arrangements.

The receiver system can be towable ocean bottom cables with data transmission directly to a boat, or also “stand-alone” receiver stations with local storage of data, which is placed out with the help of ROVs, or a combination of these.

The source itself is in the bottom of a well casing 8, in the form of a glazing hammer 9. The beatings can be used during installation of the pipe 8, or one can wait until the pipe is at the desired depth, reduce the energy so that the pipes do not move downwards when the hammer 9 beats, to obtain in this way repeatable beats while the registering is conducted. The source is several tenfold of metres below the ocean bottom, where a good mechanical connection is obtained against the surrounding sediments. The source beats with repeatable energy, controlled from the vessel 12 or to pre-programmed values. One can also situate the pole with more traditional seismic vibrators.

In that the hammer 9 is at the point of pipe 8, one will be able to use relatively thin-walled pipes and still obtain deep penetration of the pole. This is advantageous with regard to seismic energy transmission to surrounding soil, and also that thin-walled pipes give a lower frequency signal.

The registering system according to FIG. 1 comprises a receiver system, encompassing a cable 1 connected to an ocean bottom cable 2 comprising multi-component sensor units 3, such as geophones and/or hydrophones. An anchor 5 ensures a minimal tension in the ocean bottom cable, while ploughshares can be connected directly to each sensor unit 3, so that the best possible connection between sensor unit 3 and sediments is obtained. The cables are constructed so that they can be pulled along the ocean bottom with the use of a winch 14 onboard the vessel 12. A coupling unit 6 between the ocean bottom cable 2 and the source 13 ensures that the cable is pulled in a precise position towards the source. The mentioned unit 6 is connected between the two cables 1 and 11. Alternatively, the cable 1 can be a pulling-in cable only, where storage unit 2 that stores the volume of seismic data is fitted at the end of the ocean bottom cable 2, and only acoustically transmits critical data that is required to quality assure the collecting.

The seismic source comprises a hammer 9 that encompasses a control unit 7 uppermost in the source. This is connected to the well casing 8, which has the hammer, 9, itself at the end. A supporting frame 10 provides an ocean bottom reference and ensures initial vertical positioning for the installation of the pole. The mentioned support frame 10 can, in addition, represent a main reference point for the pulling in of the cable(s) 3. The cable 11, such as a reinforced umbilical, comprises the necessary control cables, such as electrical, optical and/or pneumatic conductors, to drive the source and quality assure the operation of it.

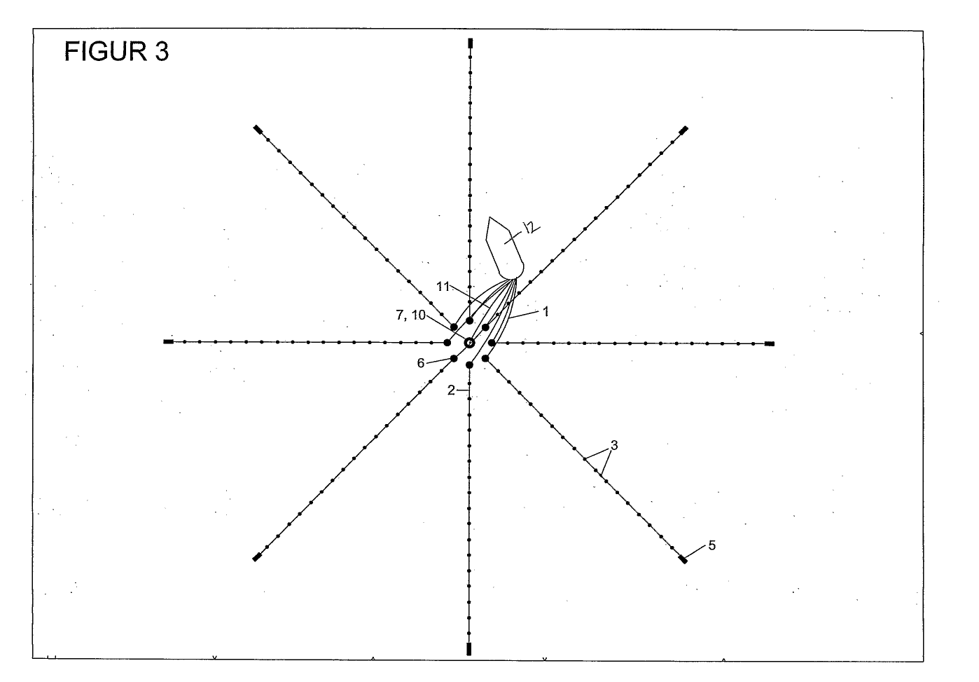

Of special interest will be, based on a model of a potential oilfield, to pre-install a certain number of “multi-purpose” well casings with the help of hydraulic hammers from a ship. While one carries out these installations, one will at the same time be able to conduct multi-component seismic in a star formation, such as shown in FIG. 3, out from the centre source/pole. Such a multi-component seismology, collected before the explorative drilling, will be of considerable importance for how one chooses to develop the field further. One will then have valuable seismic information, that will increase the possibility to find oil/gas at the first attempt, at the same time as it will drastically reduce the risk of incidents during the first drilling in the area.

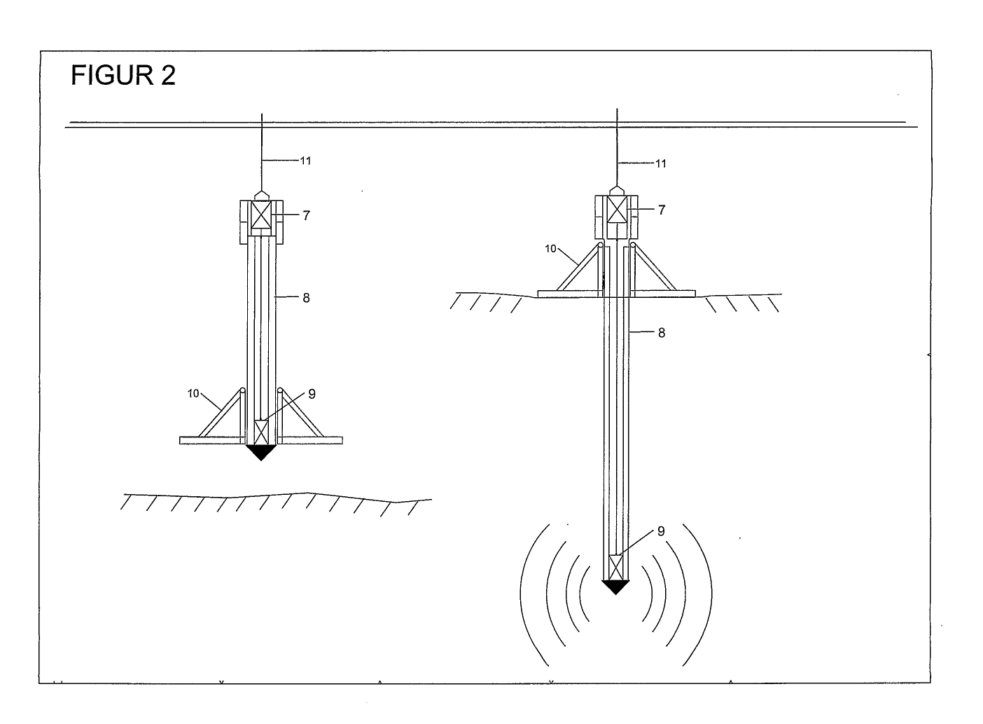

FIG. 2 shows the source in more detail, comprising, for example, hammer 9 and pole 8. The dimensions of pipe 8 can vary according to the type of investigation. A well casing for an exploration well can typically be 0.75-1.1 m in diameter and 20-50 m long. A hydraulic hammer 9, which is to install such a pipe stands internally in the bottom of the pipe. In this way, a relatively thin-walled pipe can be used, giving a good acoustic connection to the sediments. The hammer is preferably hydraulically driven, but electrical and hydrostatic operation can also be used. Hydrostatic operation can be especially relevant at great depths (>1000 m) and with smaller diameter pipes. The pipe 8 is knocked down into the sediments with the help of the hammer 9, so that the pipe 8 comes down to a depth where there is good mechanical connection to the surrounding sediments. In this way, one has the possibility to get the source down into, or below a hard surface layer, which is common for some locations. Such surface layers cause considerable problems, because it is very difficult to transmit acoustic energy down into and through such a layer.

By using large diameter well casings, the pipe, 8, itself will be left standing in the sediment as a “multi-purpose” pole, which can later be used for explorative or production drilling, as a stationary point in connection with larger marine operations and anchorage of temporary or permanent floating arrangements or for use as a source location for future seismic investigations. One can return on later occasions and carry out multi-component seismology and, in this way, obtain a 3D picture of the development of the reservoir over time (4D).

FIG. 3 shows an exemplified embodiment of using a plurality of cables in a patterned formation for registering seismic data. The cables are placed in a pattern based on prior 3D seismology interpretations. This can be a non-symmetrical pattern, or it can be in the form of a symmetric star formation, as shown in FIG. 3. Ocean bottom cables 2 are placed in the desired geometry and offset from a central location for a well casing. The well casing is installed, and multi-component seismology is registered continuously. The cables 2 are pulled successively in towards the source 13. The registering itself can be carried out during the installation of the well casing. To get as many repeatable signals from the source as possible, and obtain the highest possible quality of the data, it will be natural to reduce the hammer energy so that the well casing does not move downwards while one conducts the registering. One will still have more than enough energy to carry out deep-seismic registrations.

By placing several cables 2, in a star configuration out from the source, one will obtain a spatial resolution over a large area, where the spatial resolution increases towards the source 13, as the receivers are pulled in towards said source 13. This opens for coverage over large areas, where the coverage increases towards the area one is most interested in. By pulling the cables 2 in toward the source, while the source 13 is stationary, the productivity will be relatively large. By pulling in two oppositely directed cables at the same time, the horizontal forces on the pole will be balanced out.

An alternative use of the method is as 2D multi-component marine seismic data collection, for example, along a potential pipe route. The source, which is then driven hydraulically, hydrostatically or electrically, sits in the bottom of a pipe with a diameter of approximately 0.2 m. The acquisition cable is connected via a coupling element to an ocean bottom frame for this source. The vessel lays out a cable and moves to shooting position, while the cable 2 remains stationary, and where the source is lowered. It settles down to a desired sediment depth and one starts the registering, and pulls the cable continuously in toward the source. When the cable is close enough, the source is hoisted up and the vessel moves to the next shooting position, and the process is repeated. In this way, one has a marine method to collect 2D multi-component seismology, with an improved productivity compared with the state of the art. The method permits relatively large pulling-in forces and thereby long cables, as the source is an anchorage point for the listening cable.

Such a 2D multi-component seismic profile can be a ground seismic registering of uncompacted material in connection with route investigations, or a deep seismic registering, all depending on the parameters for the operation.

Of special interest will be to arrange the cable geometry in those directions it is most relevant to drill. One will then obtain valuable data, which makes one able to decide on the optimal drilling direction towards the reservoir, in regard to reduction of risk of meeting geological risk-zones with subsequent operating problems and potential pollution problems.

1. Method for collection and registration of acoustic, seismic and geological data at the ocean bottom and underlying formations, based on produced noise from a seismic source (13), where one or more ocean bottom cables (2) comprising sensor units (3), a data collecting unit and means for transmitting data to the data collecting unit are used, characterised in that acoustic signals are measured and are registered with the help of the sensor units (3) as an equipment element is lowered down into the ocean bottom, where the seismic source (13) comprises the mentioned equipment element, and where the acoustic signals are provided by the mentioned noise that is generated by the lowering down and/or installation of the equipment element.

2. Method for collection and registration of acoustic, seismic and geological data at the ocean bottom and underlying formations, based on produced noise from a seismic source (13), where one or more ocean bottom cables (2), comprising sensor units (3), a data collecting unit and means for transmission of data to the data collecting unit are used, where acoustic signals are measured and registered with the help of the sensor units (3), characterised in that the ocean bottom cable or ocean bottom cables (2) are moved in relation to the seismic source (13) a number of times during one measuring period.

3. Method for collection and registration of acoustic, seismic and geological data at the ocean bottom and underlying formations, based on produced noise from a seismic source (13), where one or more ocean bottom cables (2), comprising sensor units (3), a data collecting unit, and means for transmission of data to the data collecting unit are used, where acoustic signals are measured and are registered with the help of the sensor units (3), characterised in that
acoustic signals are measured and are registered with the help of the sensor units (3) as the well casing is led down into the ocean bottom, where the acoustic signals are provided by the mentioned noise that is generated in the lowering-down and/or installation of the equipment element, and in that
the ocean bottom cable or the ocean bottom cables (2) are moved in relation to the acoustic source (3) a number of times during one measuring period.

4. Method according to claim 2 or 3, characterised in that the moving of the number of cables (2) is carried out by pulling the mentioned number of cables in toward the source (13).

5. Method according to one of the claims 2-4, characterised in that several ocean bottom cables are arranged in a star configuration with the acoustic source as the central point, where the ocean bottom cables are pulled in towards the acoustic source during one measuring period.

6. Method according to one of the claims 1-5, characterised in that said equipment element is selected from the group comprising well casings, poles, equipment pipes or similar elements, where the equipment element is fed down towards the ocean bottom by vibration, drilling, hammering or the like.

7. Method according to one of the claims 1-6, characterised in that the seismic source (13) is hoisted at the end of the measuring period and moved by a vessel (12) to a new location where the same number of ocean bottom cables (2) are used to carry out new measurements.

8. Method according to one of the claims 1-7, characterised in that thin-walled pipes are used to provide a low-frequency seismic signal.
